(19) United States
(12) Patent Application Publication
(10) Pub. No.: US 2013/0304491 A1
(43) Pub. Date: Nov. 14, 2013

(54) MEDICAL INFORMATION VERIFICATION SYSTEM

(71) Applicants: Toshiba Medical Systems Corporation, Otawara-shi (JP); Kabushiki Kaisha Toshiba, Minato-ku (JP)

(72) Inventor: Takumi YOSHIDOME, Utsunomiya-shi (JP)

(21) Appl. No.: 13/938,839

(22) Filed: Jul. 10, 2013

Related U.S. Application Data
(63) Continuation of application No. PCT/JP2013/002795, filed on Apr. 24, 2013.

(30) Foreign Application Priority Data
Apr. 25, 2012 (JP) 2012-100175

(51) Int. Cl. G06F 19/00

(52) U.S. Cl. CPC G06F 19/321
USPC 705/2

(57) ABSTRACT

A medical information verification system according to an embodiment comprises a time stamp management unit which includes: a medium information storage unit configured to acquire/store medium information calculated based on information of a medical management target file to be stored in a medium; a verification identification value generation unit configured to generate a medical management target file group by bundling the medium information of different media and generating a verification identification value corresponding to the medical management target file group; a time stamp acquisition unit configured to acquire a time stamp to be added to the verification identification value from a certificate authority; a time stamp information storage unit configured to store time stamp information of the time stamp in association with the medical management target file group; and a time stamp information transmission unit configured to transmit the time stamp information in response to time stamp inquiry requests.

### CROSS-REFERENCE TO RELATED APPLICATION

This application is a continuation of International Application No. PCT/JP2013/002795, filed on Apr. 24, 2013, which is based upon and claims the benefit of priority from the prior Japanese Patent application No. 2012-100175, filed on Apr. 25, 2012, the entire contents of which are incorporated herein by reference.

### FIELD

Embodiments of the present invention relate to a medical information verification system that verifies authenticity of medical information.

### BACKGROUND

Recently, under regional cooperation among medical institutions, the portable medium (a DVD disk, a Blu-ray Disc, a USB memory or the like) that stores medical information including medical images is used as an information transmitting means. However, the portable medium is required to have information authenticity and, for example, a CA (Certificate Authority) certificate issued by Medical Information System Development Center (MEDIS-DC) or a time stamp issued by TSA (Time Stamp Authority) is added thereto. The CA certificate is capable of certifying “where and who” has created data, and the time stamp is capable of certifying “absence of data modification after a given time point”. In general, expiration date/time of the CA certificate and that of the time stamp are about two years and about ten years, respectively. Thus, by adding the time stamp to the CA certificate, it is possible to extend an authentication period and ensure authenticity of the medical information.

A cost of requesting the TSA to issue the time stamp is calculated based on a per-usage rate and, thus, when the time stamp is acquired for a portable medium that stores information for which it is unclear whether authenticity thereof is required to be verified over a long period of time, the cost for it may result in waste. Further, when the time stamp is added to each item of all the medical information stored in the portable medium, the cost for the TSA authentication is increased to increase financial burden on users.

Further, there occurs a problem of how the authenticity of the portable medium is verified when the expiration date/time of the CA certificate or time stamp expires.

Further, because of security reasons, it is often impossible to directly request the TSA for the time stamp through modalities connected to an intra-hospital network such as an HIS (Hospital Information System) and a PACS (Picture Archiving and Communication System). In such a case, medical information including a medical image, a diagnostic report, and the like is once transferred to a “regional cooperation room” in a hospital, and then a CA certificate holder acquires the time stamp for the medical information from the TSA and creates a potable medium in which the medical information added with the time stamp is stored.

Further, the time stamp is commonly acquired at a predetermined interval, such as hourly, daily, or the like, so that much time is taken for the portable medium to reach a patient. This impairs convenience of the patient and results in failure of emergency care. It is therefore an object of an embodiment of the present invention to provide a medical information verification system capable of solving the above problems and ensuring the authenticity at low cost.

### BRIEF DESCRIPTION OF THE DRAWINGS

FIG. 1 is an entire configuration diagram of a medical information verification system according to a first embodiment of the present invention;

FIG. 2 is a block configuration diagram of a medium creation means according to the first embodiment;

FIG. 3 is a block configuration diagram of a time stamp management means according to the first embodiment;

FIG. 4 is a block configuration diagram of a medium verification means according to the first embodiment;

FIG. 5 is a flowchart of a procedure of verifying authenticity of a portable medium according to the first embodiment;

FIG. 6 is an example of a database of a time stamp management section according to the first embodiment;

FIG. 7 is a flowchart of a procedure of verifying authenticity of a recordable type portable medium according to a second embodiment of the present invention;

FIG. 8 is an example of a time stamp management database for the recordable type portable medium according to the second embodiment;

FIG. 9 is an example of acquisition of a time stamp for an additional record according to the second embodiment;

FIG. 10 is an entire configuration diagram of a medical information verification system according to a third embodiment of the present invention;

FIG. 11 is a flowchart of a procedure of verifying authenticity of a portable medium according to the third embodiment; and

FIG. 12 is a flowchart of a procedure of verifying authenticity of a recordable type portable medium according to the third embodiment.

### DETAILED DESCRIPTION

A medical information verification system according to an embodiment comprises a time stamp management unit. The time stamp management unit includes: a medium information storage unit configured to acquire/store medium information calculated based on information of a medical management target file to be stored in a medium; a verification identification value generation unit configured to generate a medical management target file group by bundling the medium information of different media and generating a verification identification value corresponding to the medical management target file group; a time stamp acquisition unit configured to acquire a time stamp to be added to the verification identification value from a certificate authority; a time stamp information storage unit configured to store time stamp information of the time stamp in association with the medical management target file group; and a time stamp information transmission unit configured to transmit the time stamp information in response to a time stamp inquiry request transmitted over a network.

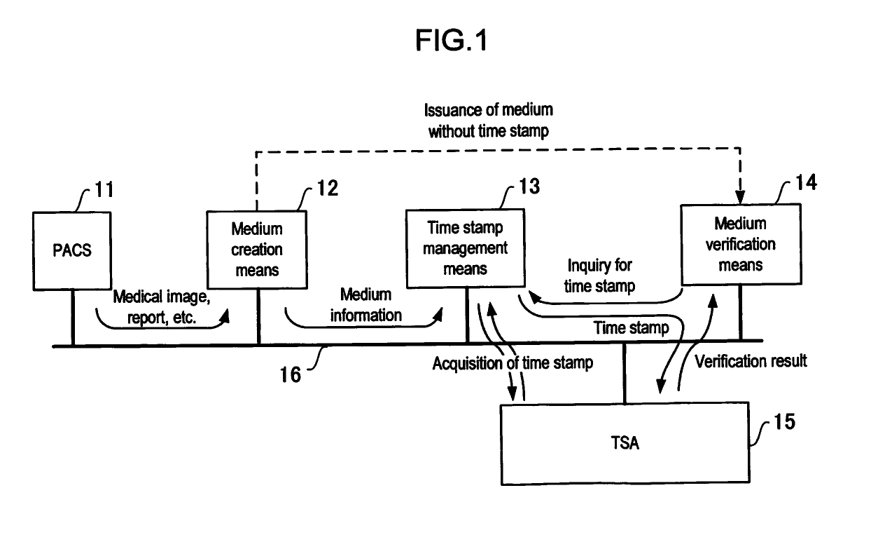

Hereinafter, embodiments for practicing the present invention will be described in detail with reference to FIGS. 1 to 12. A medical information verification system according to each of embodiments of the present invention can be constructed in cooperation with a system such as a HIS, a RIS (Radiography Information System), or PACS and thus can easily acquire consistency with the existing system.

### First Embodiment

As described above, adding the time stamp to each item of all the medical information stored in the portable medium poses various problems. However, a deeper consideration about the authenticity of the medical information makes it apparent that it is sufficient to be able to verify, through a third party, that an exact time at which the portable medium is created is not necessary and that no modification is made to the medical information stored in the portable medium at a time when a receiver (patient or hospital that has received a referral letter) of the portable medium views the information.

Thus, in the present embodiment, a medical information verification system capable of achieving the following requirements will be described:

(1) A portable medium creator provides the time stamp by the viewing (verification) time; and

(2) A portable medium receiver receives the time stamp at the viewing (verification) time.

FIG. 1 is an entire configuration diagram of a medical information verification system according to the present embodiment. As illustrated in FIG. 1, the medical information verification system of the present embodiment includes a PACS 11 that stores medical information including a medical image, a diagnostic report, and the like, a medium creation means 12 for storing the medical information in a portable medium, a time stamp management means 13 for acquiring a time stamp after issuance of the portable medium and managing medium information of the portable medium and time stamp information of the medical information, a medium verification means 14 for verifying authenticity of the medical information stored in the portable medium after the issuance of the portable medium, and a TSA 15. The PACS 11, medium creation means 12, time stamp management means 13, medium verification means 14, and TSA 15 are connected to a network 16 and configured to be communicable with each other.

As denoted by a broken arrow, the time stamp is not acquired upon issuance of the portable medium, and the portable medium without the time stamp is handed over to a portable medium receiver immediately after the issuance. The time stamp management means 13 acquires the time stamp after the issuance of the portable medium, and the portable medium receiver uses the medium verification means 14 to retrieve the medical information in a hospital that has received a referral letter. The medium verification means 14 requests the time stamp management means 13 for the time stamp and uses the time stamp to perform authentication in the TSA 15 to thereby achieve verification of the medical information.

In the present embodiment, medical information for which the authenticity is required is defined as a medical management target file, and this term will be used hereinafter. The medical management target file includes various medical information including a medical image, a diagnostic report, and the like and further includes link information to access the medical information when the medical information cannot directly be stored in the portable medium for privacy or security reasons. The medical management target file includes a file compliant or not compliant with a DICOM (Digital Imaging Communication in Medicine) standard and, hereinafter, a file compliant with the DICOM will be described.

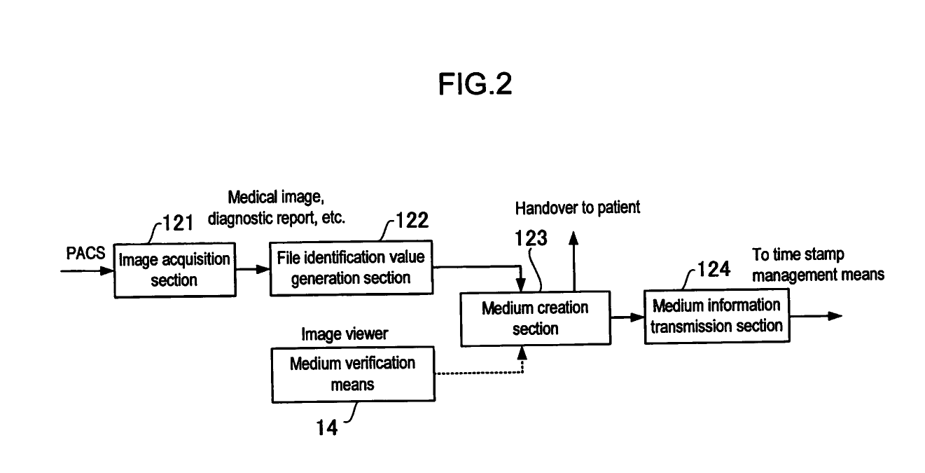

FIG. 2 is a block configuration diagram of the medium creation means 12 according to the present embodiment. As illustrated in FIG. 2, the medium creation means 12 includes an image acquisition section 121, a file identification value generation section 122, a medium creation section 123, and a medium information transmission section 124. As denoted by a broken arrow, when the medium verification means 14 is incorporated in an image viewer in the form of an application to be described later and thus included in the portable medium, highly convenient operation can be performed. The medium creation means 12 can be embodied as a terminal device such as a personal computer.

The image acquisition section 121 acquires the medical management target file to be carried by a patient from the PACS 11 or a modality and temporarily retains the acquired medical management target file until the potable medium is created.

The file identification value generation section 122 generates a file identification value for each of all the medical management target files to be made portable so as to uniquely identify the individual files. In the present embodiment, a hash value is used as the file identification value, and this will be hereinafter referred to as “file hash value”.

The medium creation section 123 stores the medical management target file to be made portable in the portable medium. In the present embodiment, an index file for managing a plurality of medical management target files as a tree structure is used, and the index file is set as a time stamp management target. The index file (e.g., DICOMDIR) stores file identification values (file hash values) of the individual tree-structured medical management target files.

The index file, a file identification value (file hash value) of the index file, and the tree-structured medical management target files are stored in the portable medium, but the time stump is not stored therein. Preferably, an image viewer (medium verification means 14) is included in the portable medium, through which the portable medium receiver views/verifies, in the referred hospital, the medical management target file stored in the portable medium. A medium identifier, by which the potable medium itself is uniquely identified, is assigned to the portable medium. For example, a volume label can be used as a value of the medium identifier (a medium identification value).

The medium information transmission section 124 transmits, after creation of the portable medium, medium information including the medium identifier, an index file name stored in the portable medium, the file identification value (file hash value) of the index file, and the like to the time stamp management means 13.

Alternatively, it is possible to transmit the index file itself to the time stamp management means 13 and then to calculate the file identification value (file hash value) from the index file. Further, in a case where the medium creation means 12 and time stamp management means 13 exist in the same location, the medium information need not be transmitted through the network, but may directly be stored in the time stamp management means 13.

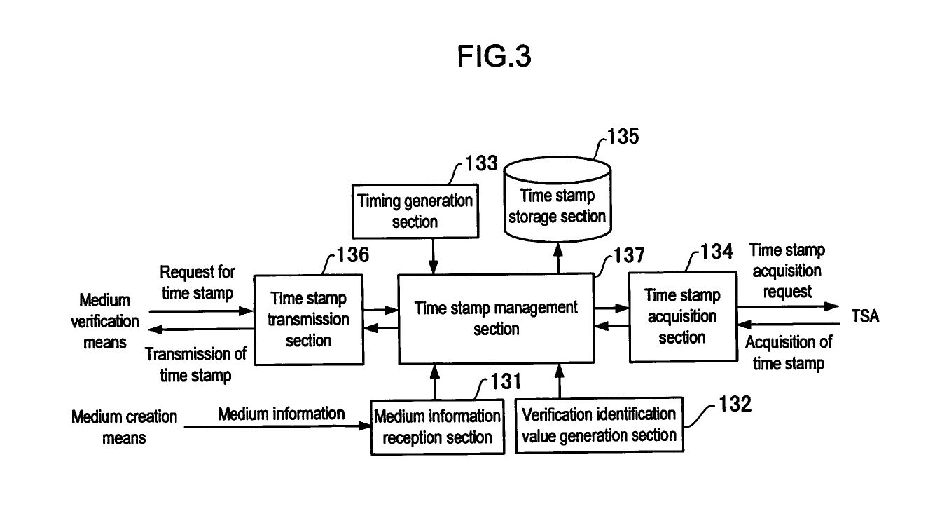

FIG. 3 is a block configuration diagram of the time stamp management means 13. The time stamp management means 13 includes a medium information reception section 131, a verification identification value generation section 132, a timing generation section 133, a time stamp acquisition section 134, a time stamp storage section 135, a time stamp transmission section 136, and a time stamp management section 137 as illustrated in FIG. 3.

The medium information reception section 131 receives the medium information from the medium information transmission section 124 of the medium creation means 12 and temporarily retains the received medium information. The medium information includes the medium identifier, index file name stored in the portable medium, the file identification value (file hash value) of the index file, and the like. As described later, the medium information is stored in the time stamp storage section 135 in association with a time stamp and a medical management target group.

The verification identification value generation section 132 creates a verification identification value used in acquiring the time stamp from the TSA 15. The verification identification value can uniquely identify a medical management target group obtained by bundling one or more portable media to each of which the time stamp has not been added. Specifically, the verification identification value is created based on the file hash value of the medical management target file stored in the portable medium, the medium identifier, or the like. When the hash value is used for creation of the verification identification value, the obtained value is referred to as “verification hash value”. As described above, one time stamp is acquired for the medical target file group obtained by bundling one or more medical management target files, so that cost required to acquire the time stamp can be reduced.

The timing generation section 133 generates a timing serving as a trigger for acquiring the time stamp from the TSA 15. The timing generation includes (1) a periodic timer request and (2) a request upon time stamp verification. In the periodic timer request, the medium information to be recorded in a database of the time stamp storage section 135 is periodically checked to confirm whether there is any portable medium to which the time stamp has not been added and, when there is any portable medium without the time stamp, a time stamp acquisition request is made to the TSA 15. In the request upon time stamp verification, the acquisition request timing is generated according to a request from the medium verification means 14. Incidentally, in the periodic timer request, it may further be checked whether the number of the portable media without the time stamp reaches a predetermined number. The more the number of the portable media to be bundled together, the less the cost required for the time stamp acquisition, resulting in improvement of efficiency. In this regard, however, the time stamp is preferably acquired before reception of the request upon time stamp verification from the medium verification means 14 of the referred hospital, so that the time stamp acquisition timing is determined according to an actual operational status.

The time stamp acquisition section 134 acquires the time stamp from the TSA 15 using the verification identification value at the time stamp acquisition timing set by the timing generation section 133.

The time stamp storage section 135 stores the time stamp information, verification identification value, medium information, and the like acquired from the TSA 15 in association with the medical management target file group. The stored information are collectively referred to as “management information”.

The time stamp transmission section 136 replies to a time stamp information inquiry request transmitted from the medium verification means 14 upon verification of the medium and transmits the time stamp information acquired from the TSA 15 to the medium verification means 14 over the network.

The time stamp management section 137 integrally controls the medium information reception section 131, verification identification value generation section 132, timing generation section 133, time stamp acquisition section 134, time stamp storage section 135, and time stamp transmission section 136.

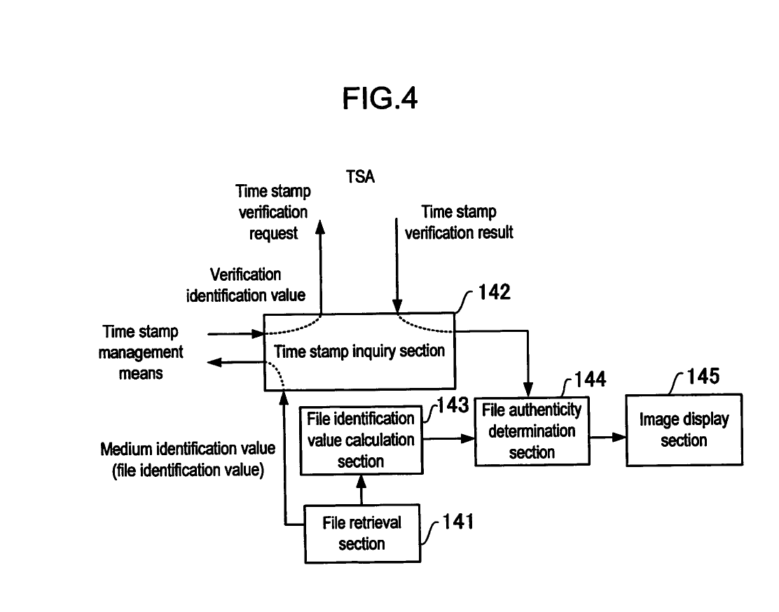

FIG. 4 is a block configuration diagram of the medium verification means 14. The medium verification means 14 has a file retrieval section 141, a time stamp inquiry section 142, a file identification value calculation section 143, a file authenticity determination section 144, and an image display section 145. The medium verification means 14 is embodied as a terminal device such as a personal computer, and a function thereof is achieved by executing an image viewer application included in the portable medium. Alternatively, an image viewer application having a function of the medium verification means 14 may previously be installed in the terminal device.

The file retrieval section 141 retrieves the medical management target file stored in the portable medium. The time stamp inquiry section 142 uses the medium identification value and file identification value to acquire the time stamps added respectively to the portable medium and medical management target file and verification identification values (verification hash values) used in generation thereof from the time stamp transmission section 136 of the time stamp management means 13. Then, the time stamp inquiry section 142 uses the acquired time stamps and verification identification values to make the TSA 15 verify the time stamps.

The file identification value calculation section 143 calculates the file identification value (file hash value) of the medical management target file stored in the portable medium.

The file authenticity determination section 144 confirms that the file identification value (file hash value) of the medical management target file calculated by the file identification value calculation section 143 and file identification value (file hash value) described in the index file are identical and further confirms, from an acquired verification result, that the medical management target file is within its expiration date/time. The image display section 145 displays the medical management target file on a monitor of the terminal device.

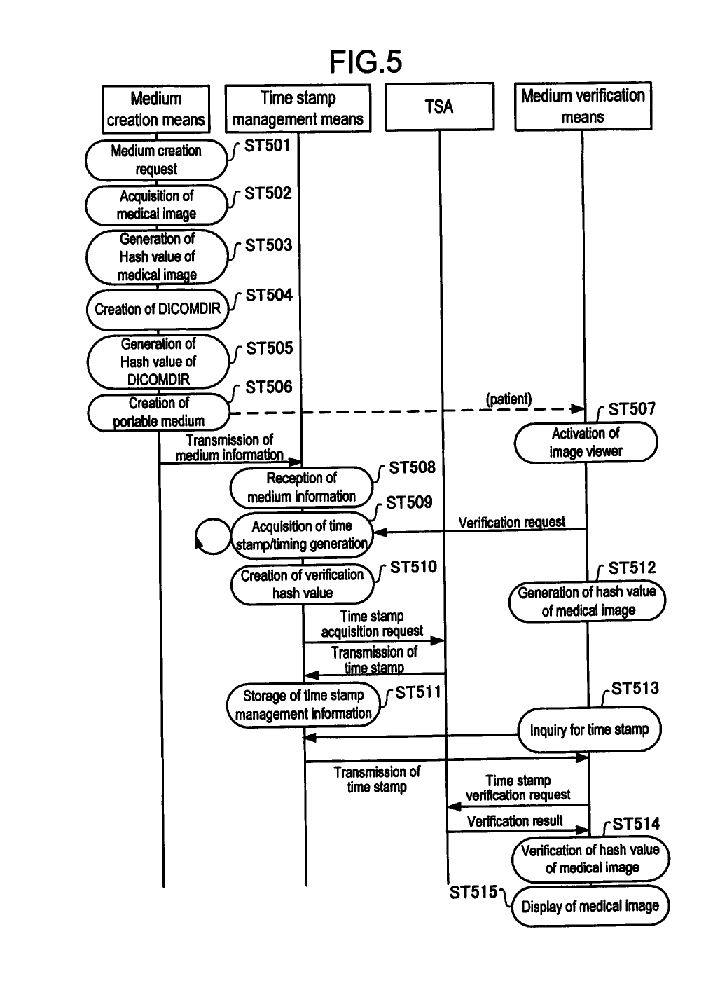

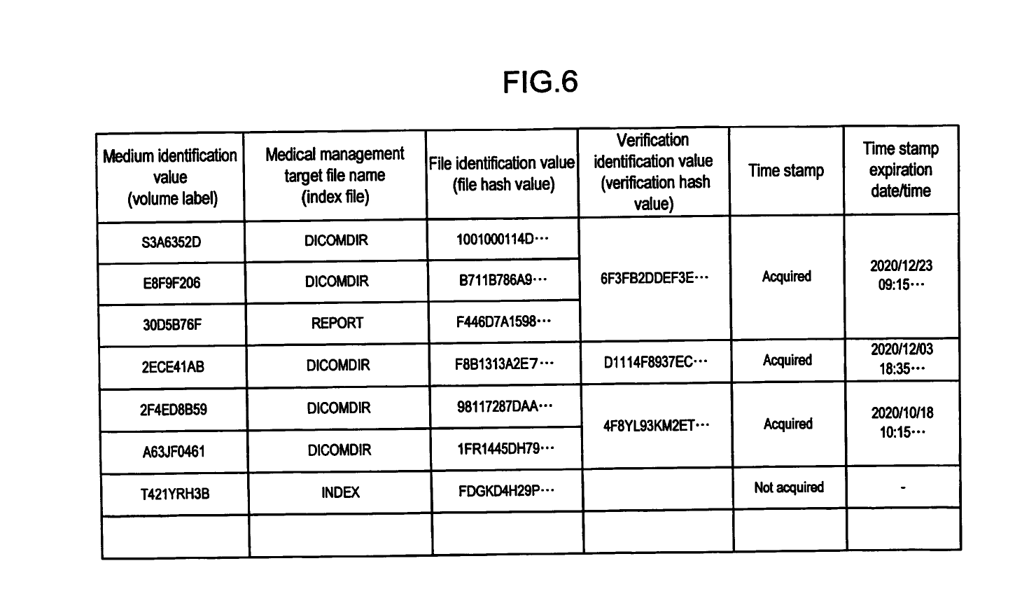

The following describes operation of the medical information verification system having the above configuration. FIG. 5 is a flowchart of a procedure of verifying authenticity of the portable medium, and FIG. 6 is an example of a database managed by the time stamp management section 137 (time stamp storage section 135).

The flowchart of FIG. 5 illustrates a flow of processing to be performed among the medium creation means 12, time stamp management means 13, TSA 15, and medium verification means 14.

In step ST501, a doctor (hospital) that refers a patient to another hospital (hereinafter, referred to “referred hospital”) requests the medium creation means 12 to create a portable medium to be handed over to the another hospital.

In step ST502, the medium creation means 12 acquires a required medical management target file including the medical image, diagnostic report, and the like from the PACS 11, HIS, or modality. Then, the medium creation means 12 calculates the file hash value of the medical management target file (step ST503). When there are a plurality of the medical management target files, the medium creation means 12 creates the index file (e.g., DICOMDIR) (step ST504) and calculates the file hash value of the created index file (step ST505).

In step ST505, the medium creation means 12 describes the file hash value of the medical management target file in the index file. Then, in step ST506, the medium creation means 12 stores the medical management target file with the index file as a root to create the portable medium. At this time, in the present embodiment, the CA certificate is also stored in the portable medium. Preferably, the image viewer application capable of executing a function of the medium verification means 14 is also stored in the portable medium.

Immediately after the creation of the portable medium, this portable medium is issued to a patient, allowing the contents of the portable medium to be viewed by the patient or a doctor of a referred hospital. Specifically, the image viewer application included in the portable medium is activated to request the time stamp management means 13 to verify the portable medium (step ST507).

Further, after the creation of the portable medium in step ST506, the medium creation means 12 transmits to the time stamp management means 13 medium information including a volume label of the created portable medium, a name of the index file (DICOMDIR) serving as a root of a tree structure (if the created medical management target files are organized in a tree structure) or a name of the medical management target file itself (if the created medical management target files are not organized a tree structure), and the like.

In step ST508, the time stamp management means 13 receives the medium information of the portable medium and stores the received medium information in the time stamp storage section 135. As illustrated in FIG. 6, a database stored in the time stamp storage section 135 manages the management information including a medium identification value (volume label), a medical management target file name (index file (DICOMDIR, etc.) name, if the medical management target file has a tree structure), a file identification value (file hash value), a verification identification value (verification hash value), a time stamp, and time stamp information such as a time stamp expiration date/time. When receiving the medium information, the time stamp management means 13 stores the medium identification value (volume label), medical management target file name (index file (DICOMDIR, etc.) name, if the medical management target file has a tree structure), and file identification value (file hash value). Taking the first line of the database table of FIG. 6 as an example, the medium identification value (volume label) is “S3A6352D”, medical management target file name is “DICOMDIR”, and file identification value (file hash value) is “1001000114D . . . ”.

In step ST509, the time stamp management means 13 generates a timing serving as a trigger for the time stamp acquisition. As described above, the timing generation includes the periodic timer request in which when there is any portable medium without the time stamp, a time stamp acquisition request is made to the TSA 15 and request upon time stamp verification in which the acquisition request timing is generated according to a request from the medium verification means 14. In a normal operation state, a setting is preferably made such that the periodic timer request for time stamp acquisition is generated before the activation of the image viewer in step ST507.

In step ST510, the time stamp management means 13 generates the verification identification value (verification hash value) for time stamp acquisition based on the timing generation of step ST509. This verification hash value is generated for a group of a plurality of portable media without the time stamp. For example, the verification hash value may be generated from the file hash values of a plurality of the medical management target files.

In step ST511, the time stamp management means 13 uses the verification hash value to acquire the time stamp from the TSA 15 and stores the acquired time stamp in the time stamp storage section 135. Taking the first line of the database table of FIG. 6 as an example, the verification hash value is “6F3FB2DDEF3E . . . ”, time stamp is “acquired”, and time stamp expiration date/time is “2020/12/23 09:15 . . . ”.

In step ST512, the medium verification means 14 acquires the medical management target file in the portable medium after the activation of the image viewer in step ST507 and calculates the file hash value of the medical management target file in the file identification value calculation section 143. In step ST513, the medium verification means 14 makes an inquiry to the time stamp management means 13 for the time stamp using the volume label of the portable medium as a search key and acquires a time stamp matching the volume label and verification hash value used for acquisition of the time stamp.

In a case where there exist a plurality of volume labels having the same value in the database of the time stamp storage section 135 due to update of the portable medium such as addition of a new medical image, the medium verification means 14 may make an inquiry for the file hash value of the medical management target file in the portable medium together with the volume label. Such an embodiment will be described later.

The medium verification means 14 uses the acquired time stamp and verification hash value to verify authenticity of the portable medium in the TSA 15.

In step ST514, the medium verification means 14 compares the file hash value calculated in step ST512 with the file hash value described in the index file in the portable medium in the file authenticity determination section 144 to confirm identity of the medical management target file.

In step ST515, the medium verification means 14 displays the medical management target file on the monitor of the terminal device on which the medium verification means 14 itself runs and certifies authenticity based on the identification of the medical management target file and verification result from the TSA 15. If the authenticity cannot be certified, a message or the like is displayed to attract attention of a viewer.

There is no method of confirming the authenticity of the stored medical information when the expiration data/time of the CA certificate of the portable medium or that of the time stamp expires in the conventional approach; however, in the present embodiment, the time stamp management means 13 checks the expiration date/time of the time stamp upon inquiry for the time stamp in step ST513 and performs reacquisition of the time stamp from the TSA 15 if the expiration date/time expires. The reacquisition may be performed automatically when it comes close to the expiration date/time for maintaining the authenticity.

As described above, according to the first embodiment, it is not necessary to immediately issue the time stamp to the portable medium (a DVD disk, a Blu-ray Disc, a USB memory, etc.) storing the medical information and being used as a means of conveying information between hospitals, so that a time required to hand over the portable medium to the patient can be reduced.

Further, since one time stamp is acquired for a plurality of the portable media, cost required for TSA authentication can be reduced.

Further, if the expiration data/time of the CA certificate or that of time stamp has expired, the time stamp can be reacquired by accessing the time stamp management means, thereby allowing the authenticity of the portable medium to be certified at all times.

### Second Embodiment

The portable medium includes a medium (recordable type medium) to which data can be added, and there may be a case where new medical information needs to be added in a referred hospital. In such a case, it is unfavorable to use the medium creation means 12 of the referring hospital for data addition because of administrative reasons or convenience reasons.

In the present embodiment, a case where new medical information is added to such a recordable-type portable medium using a medium creation means of the referred hospital will be described.

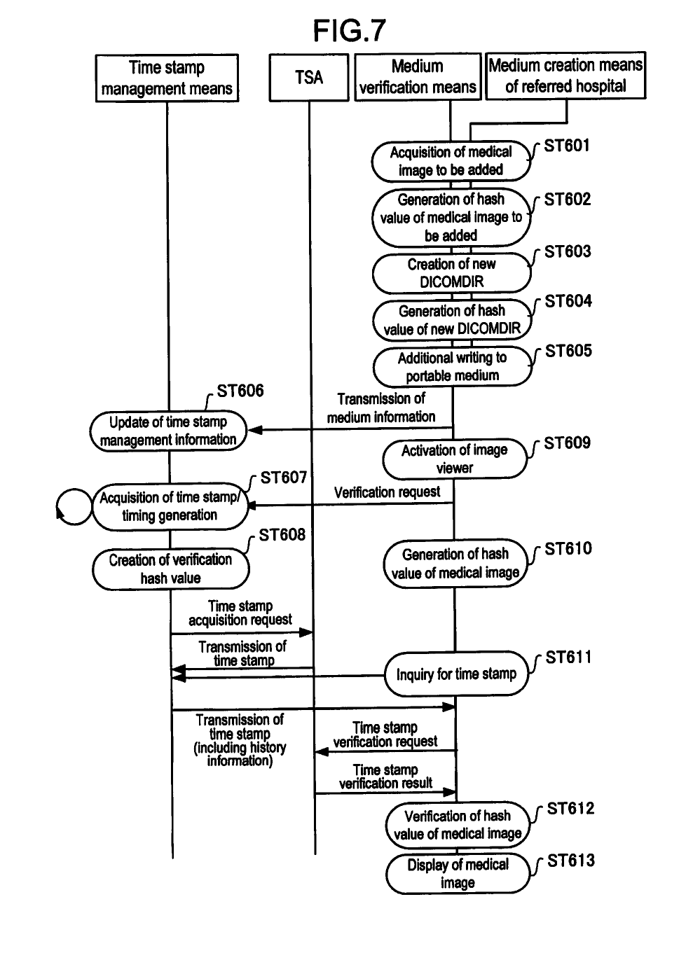

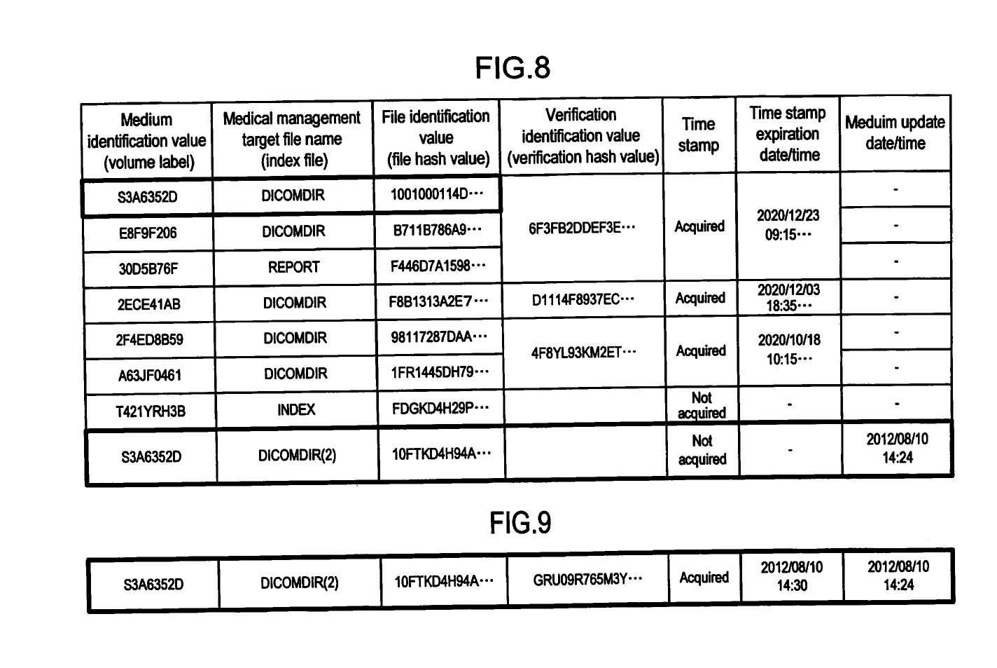

FIG. 7 is a flowchart of a procedure of verifying authenticity of a recordable type portable medium, and FIG. 8 is an example of a time stamp management database for the recordable type portable medium.

The flowchart of FIG. 7 illustrates a flow of processing to be performed among the time stamp management means 13, TSA 15, and medium verification means 14 or medium creation means 12 of the referred hospital.

Since the medium creation means 12 and medium verification means 14 can be implemented in the same terminal device, new medical management target file addition processing (step ST601 to step ST605) may be performed in a terminal device implementing the medium verification means.

In step ST601, the medium creation means 12 of the referred doctor or hospital acquires a medical management target file (new medical image, new diagnostic report, etc.) to be added to the recordable type portable medium from the PACS, HIS, or modality.

In step ST602, the medium creation means 12 of the referred hospital calculates the file hash value of the new medical management target file to be added. Then, the medium creation means 12 newly creates the index file (DICOMDIR, etc.) (step ST603).

In step ST604, the medium creation means 12 adds the file hash value of the new medical management target file to be added in the index file and calculates the file hash value of the new index file.

In step ST605, the medium creation means 12 adds the new medical management target file in the portable medium with the new index file as a root.

After the addition of the new medical management target file in the portable medium in step ST605, the medium creation means 12 transmits to the time stamp management means 13 medium information including a volume label of the portable medium to which the new medical management target file has been added, a name of the new index file (new DICOMDIR), a hash value of the new file, a hash value of the previous DICOMDIR, and the like.

In step ST606, the time stamp management means 13 uses the volume label, new index file name, and new file hash value included in the received medium information to create a new record. For example, as shown in the last line of the database table of FIG. 8, the new record is created like this: volume label “S3A6352D”, medical management target file name “DICOMDIR (2)”, and file identification value (file hash value) “10FTKD4H94A . . . ”.

Then, the time stamp management means 13 searches the database of the time stamp storage section 135 for a previous record using the volume label “S3A6352D” and file hash value “1001000114D . . . ” of the previous DICOMDIR as search keys. In the example of FIG. 8, a record of the first line is hit. Further, the time stamp management means stores, in a “medium update field” of the new record, information indicating that the medium has been updated. This allows management of medium update history.

In step ST607, the time stamp management means 13 generates a timing serving as a trigger for the time stamp acquisition. As in the first embodiment, the timing generation includes the periodic timer request and request upon time stamp verification in which the timing is generated according to a request from the medium verification means 14.

In step ST608, the time stamp management means 13 generates the verification identification value (verification hash value) for time stamp acquisition based on the timing generation of step ST608. This verification hash value is generated for a group of the new record created by the addition of the medical management target file and a portable medium without the time stamp, if it exists. Thereafter, the time stamp management means 13 uses the verification hash value to acquire the time stamp from the TSA 15 and stores the acquired time stamp in the time stamp storage section 135. The time stamp stored as a record of the last line as illustrated in FIG. 9 is updated from “not acquired” to “acquired” and, accordingly, the expiration date/time of the time stamp is stored.

The viewing/verification method of the newly added medical management target file is substantially the same as that employed in the first embodiment. In step ST609, the image viewer having a function of the medium verification means is activated. In step ST610, the medium verification means 14 calculates the file hash value of the medical management target file stored in the portable medium in the file identification value calculation section 143.

In step ST611, the medium verification means 14 makes an inquiry to the time stamp management means 13 for the time stamp using the volume label of the portable medium as a search key and acquires a time stamp matching the volume label and verification hash value used for acquisition of the time stamp. Since the new medical management target file has been added, a plurality of volume labels having the same value exist in the database of the time stamp storage section 135. Using only the volume label as the search key allows all the records in the portable medium corresponding to the target volume label to be hit, thereby acquiring update history information. Using the volume label and the file hash value of the latest medical management target file as the search keys allows the latest time stamp to be acquired. The medium verification means 14 then uses the acquired latest time stamp and verification hash value to verify authenticity of the portable medium in the TSA 15.

In step ST612, the medium verification means 14 compares the file hash value calculated in the file identification value calculation section 143 with the file hash value described in the index file in the portable medium in the file authenticity determination section 144 to confirm identity of the medical management target file.

In step ST613, the medium verification means 14 displays the medical management target file on the monitor of the terminal device and certifies the identification and authenticity of the medical management target file based on a verification result from the TSA 15.

As described above, according to the second embodiment, even when a new medical management target file is added to the recordable type portable medium, the authenticity of the file can be verified.

### Third Embodiment

In each of the above embodiments, the medical management target file is included in the portable medium. However, the medical management target file becomes larger in size with an increase in resolution of the medical image, so that it is not always possible to store all the medical management target files in the portable medium. Further, since the medical management target file is copied in the portable medium, the portable medium must be handled under strict management so as not to be lost. Further, it may be unfavorable to store a medical image or a diagnostic report that one does not want a patient or a third party to view. In view of such situations, in the present embodiment, one, some, or all of the medical management target files are not included in the portable medium, but are stored in a shared server that can be accessed from regional cooperating hospitals so as to be integrally managed. Thus, when the medical management target file is stored in a shared server 101, the file hash value of the medical management target file and link information thereof are stored in the portable medium.

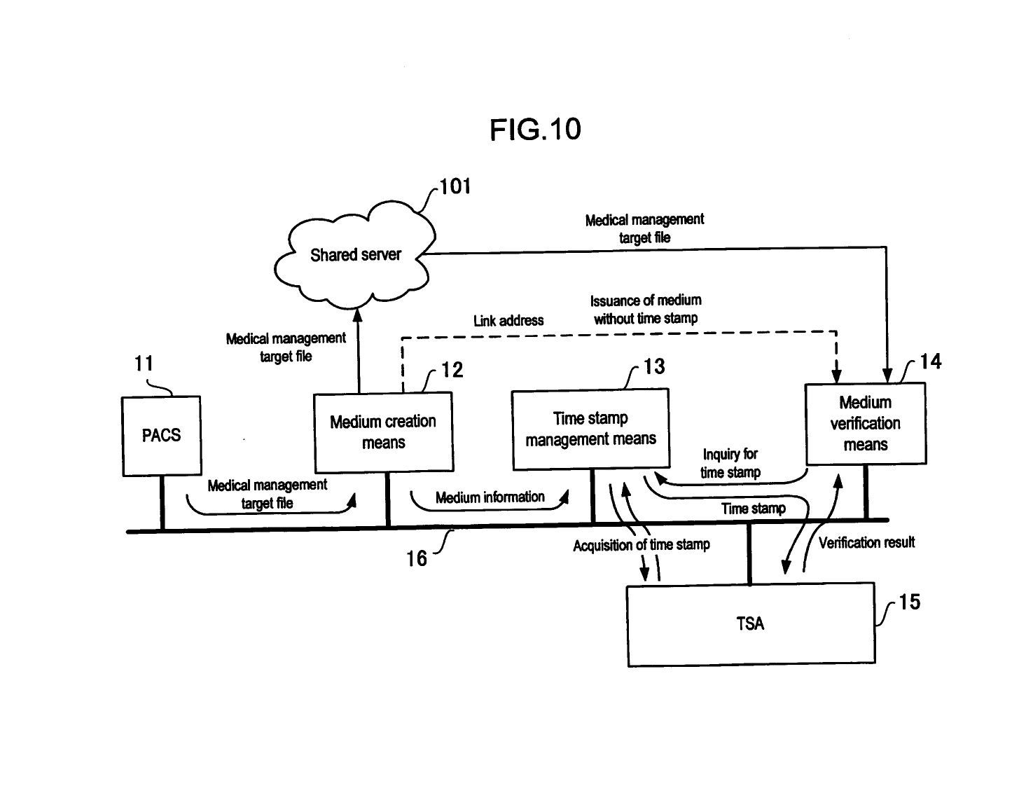

FIG. 10 is an entire configuration diagram of the medical information verification system according to the third embodiment of the present invention. As illustrated, the shared server 101 connected to the network 16 is added to the configuration of FIG. 1. The medium creation means 12 stores, in the shared server 101, a medical management target file to be viewed in any of the regional cooperating hospitals. Further, the medium creation means 12 stores, in the portable medium, the link information for accessing the medical management target file stored in the shared server 101. The shared server 101 is open to the regional cooperating hospitals, thereby allowing the regional cooperating hospitals to access the medical management target file stored in the shared server 101. The shared server 101 may be embodied as an on-premise server that operates in cooperation with the PACS, HIS, RIS, etc., in each of the hospitals or as so-called a cloud server installed outside the hospital.

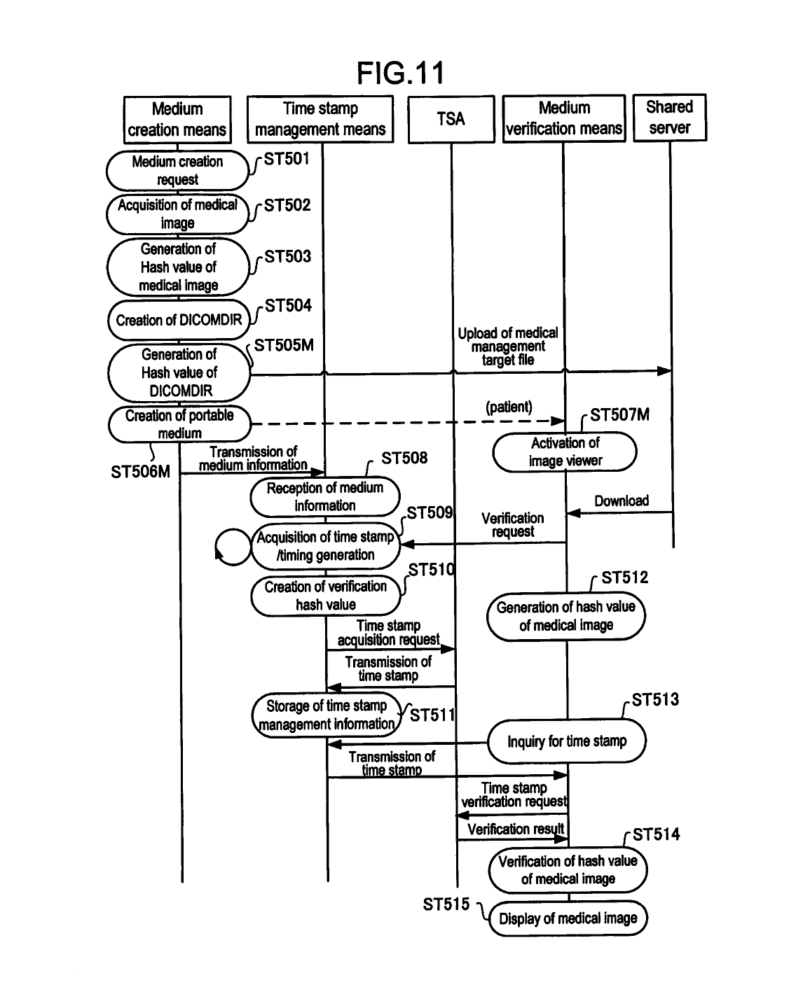

FIG. 11 is a flowchart of a procedure of verifying authenticity of the portable medium in the third embodiment. As illustrated, the following two operations are added to the flowchart of FIG. 5: a medical management target file write operation in which the medium creation means 12 writes the medical management target file in the shared server 101; and a medical management target file read operation in which the medium verification means 14 retrieves the medical management target file from the shared server 101.

Here, operation in a state where the shared server 101 is added will be described, focusing on processing from step ST505M to step ST507M. A description will be omitted in respect of steps other than step ST505M to step ST507M as these steps are identical to those of the first embodiment.

In step ST505M, the medium creation means 12 describes the file hash value of the medical management target file in the index file and generates the file hash value of the index file. Then, the medium creation means 12 does not include one, some, or all of the medical management target files in the portable medium, but uploads them to the shared server 101. After that, the medium creation means 12 acquires the link information indicating a storage location of the uploaded file on the shared server 101.

In step ST506M, the medium creation means 12 creates the portable medium in the same manner as step ST506. At this time, the medical management target file that has not been uploaded to the shared server 101 is included in the portable medium, and the link information of the medical management target file that has been uploaded to the shared server 101 is stored in the portable medium as the medium information. The link information may include an access authority to access the shared server 101 in addition to a link address indicating the storage location of the medical management target file on the shared server 101.

Immediately after the creation of the portable medium, this portable medium is issued to a patient. In step ST507M, the patient or a doctor of a referred hospital uses the medium verification means 14 to view the contents of the portable medium. Specifically, the image viewer application included in the portable medium is activated, and the link information stored in the portable medium is used to download the medical management target file from the shared server 101. Then, the medium verification means 14 requests the time stamp management means 13 to verify the portable medium.

Thus, in the present embodiment, the medical management target file is stored in the shared server 101, so that in this case it is not necessary to store the medical management target file itself in the portable medium. Also in this configuration, viewing of the medical management target file and authenticity verification thereof can be achieved by the medium verification means of the referred hospital.

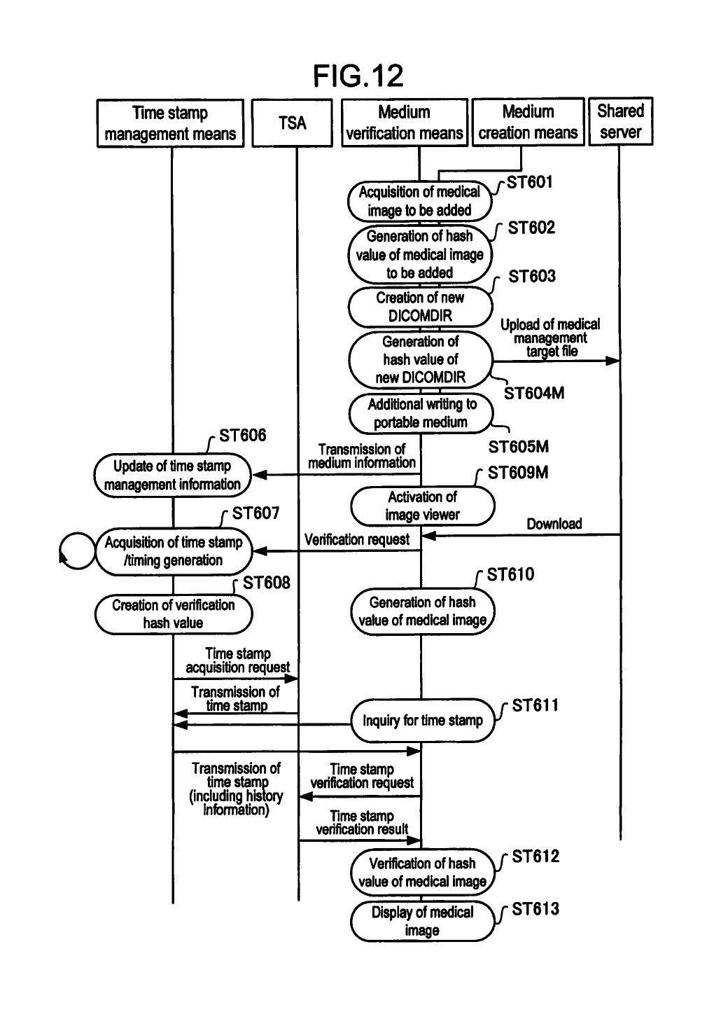

FIG. 12 is a flowchart of a procedure of verifying authenticity of the recordable type portable medium in the third embodiment. As illustrated, the following two operations are added to the flowchart of FIG. 7: a medical management target file write operation in which the medium creation means 12 of the referred hospital or the medium verification means 14 writes the medical management target file in the shared server 101; and a medical management target file read operation in which the medium verification means 14 retrieves the medical management target file from the shared server 101.

Here, operation of the shared server 101 will be described, focusing on processing from steps ST604M, ST605M, and ST609M. A description will be omitted in respect of steps other than steps ST604M, ST605M, and ST609M as these steps are identical to those of the second embodiment.

In step ST604M, the medium creation means 12 stores the file hash value of the medical management target file to be added which has been calculated in step ST602 in a new index file and then calculates the file hash value of the new index file. When the medical management target file to be added is not included in the portable medium, the medium creation means 12 uploads it to the shared server 101 and then acquires the link information to access an upload destination.

In step ST605M, the medium creation means 12 adds the new index file in the portable medium. In the portable medium, the file hash value of the medical management target file and the link information to access the medical management target file uploaded to the shared server 101 are stored. The medical management target file that has not been uploaded to the shared server 101 is added and included in the portable medium. Then, the medium creation means 12 transmits to the time stamp management means 13 medium information including a volume label of the portable medium to which the medical management target file has been added, a name of the new index file (new DICOMDIR), a hash value of the new file, a hash value of the previous DICOMDIR, and the like.

In step ST609M, the medium verification means 14 activates the image viewer. For the medical management target file that has not been included in the portable medium, the medium verification means 14 acquires the medical management target file from the shared server 101 based on the link information thereof.

As described above, it is possible to add the medical management target file in the portable medium having a small storage capacity. That is, according to the present embodiment using the shared server, it is not necessary to include a large capacity medical management target file in the portable medium. Therefore, the present embodiment can be applied to a small capacity portable medium such as an IC chip of a health insurance card. That is, in any of the regional cooperating hospitals, the authenticity verification of the medical management target file and history management thereof can be achieved with a single health insurance card, thereby significantly enhancing convenience. Further, access control can be made in the shared server, so that operation meeting security and privacy requirements can be achieved.

In each of the embodiments described above, the database handled by the time stamp management means 13 does not manage the medical management target file itself. That is, the database manages the management information such as the name of the medical management target file, name of the index file name, file hash value of the index file, and verification hash value. Thus, the time stamp storage section 135 does not require a large storage capacity. This results in a low-cost system configuration. However, the information to be managed by the database is not limited in the present invention, and the index file itself or medical management target file itself may be managed in the database. Thus, according to the embodiments of the present invention, there can be provided a medical information verification system capable of ensuring the authenticity at low cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and sprit of the inventions.

What is claimed is:

1. A medical information verification system comprising time stamp management unit, the time stamp management unit including:
medium information storage unit configured to acquire/store medium information calculated based on information of medical management target files to be stored in a medium;
verification identification value generation unit configured to generate a medical management target file group by bundling the medium information of a plurality of different media and generating a verification identification value corresponding to the medical management target file group;
time stamp acquisition unit configured to acquire a time stamp to be added to the verification identification value from a certificate authority;
time stamp information storage unit configured to store time stamp information of the time stamp in association with the medical management target file group; and
time stamp information transmission unit configured to transmit the time stamp information in response to a time stamp inquiry request transmitted over a network.

2. The medical information verification system according to claim 1, wherein
the medium information includes a medical management target file name, a file identification value by which the medical management target file can be identified, and a medium identification value for identifying the medium.

3. The medical information verification system according to claim 1, wherein
the time stamp management unit manages management information including the medium information, verification identification value, and time stamp information.

4. The medical information verification system according to claim 1, wherein
the time stamp information transmission unit transmits time stamp information corresponding to the medium information in response to the time stamp inquiry request transmitted, over the network, from medium verification unit configured to verify authenticity of the medical management target file.

5. The medical information verification system according to claim 4, wherein
the medium information includes an index file used for managing a plurality of the medical management target files as a tree structure and a file identification value of the index file, and file identification values of the plurality of medical management target files are stored in the index file.

6. The medical information verification system according to claim 5, wherein
the time stamp management unit further includes timing generation unit that generates a time stamp acquisition timing for acquiring the time stamp from the certificate authority.

7. The medical information verification system according to claim 6, wherein
the timing generation unit generates the time stamp acquisition timing based on a periodic timer request or in response to a request from the medium verification unit.

8. The medical information verification system according to claim 1, further comprising
medium verification unit configured to verify authenticity of the medical management target file, the medium verification unit including time stamp inquiry unit configured to acquire, from the time stamp management unit, the time stamp information, which corresponds to the medium identification value of the medium and file identification value recorded in the medium, and the verification identification value thereof, making an inquiry to the certificate authority using the time stamp information and verification identification value, and acquiring a result of verification for the time stamp from the certificate authority.

9. The medical information verification system according to claim 8, wherein
the medium verification unit further includes:
file retrieval unit configured to retrieve the medical management target file from the medium information;
file identification value calculation unit configured to newly calculate the file identification value from the retrieved medical management target file; and
file authenticity determination unit configured to determine identification between the newly calculated file identification value and file identification value stored in the medium and authenticity of the medical management target file from the time stamp verification result.

10. The medical information verification system according to claim 9, further comprising
medium creation unit configured to create the medium, the medium creation unit including:
medical management target file acquisition unit configured to acquire the medical management target file;
file identification value generation unit configured to generate an identifiable file identification value from the medical management target file; and
medium information transmission unit configured to transmit the medium information to the time stamp management unit upon creation of the medium.

11. The medical information verification system according to claim 10, wherein
the medium verification unit is stored in the medium as an application.

12. The medical information verification system according to claim 11, wherein
the medical management target file complies with a DICOM format, and the index file is a DICOMDIR file.

13. The medical information verification system according to claim 12, wherein
the medium identification value is a volume label of the medium, and a hash value is used for the file identification value and the verification identification value.

14. The medical information verification system according to claim 3, wherein
when the medical management target file is updated with a new medical management target file added in a recordable type medium, the time stamp management unit receives, over the network, the medium identification value of the medium to which the new medical management target file has been added, a name of the newly added medical management target file, the file identification value of the added medical management target file, and the file identification value before the update and stores them therein to store information indicating that content of the recordable type medium has been updated and manages the management information including the medium identification value after the update of the content of the recordable type medium, file identification value, verification identification value, and time stamp information.

15. The medical information verification system according to claim 10, further comprising a shared server that stores the medical management target file.

16. The medical information verification system according to claim 15, wherein
the medium verification unit further includes file retrieval unit configured to retrieve the medical management target file from the shared server.

17. The medical information verification system according to claim 16, wherein
the medium creation unit includes file writing unit configured to write one, some, or all of the medical management target files in the shared server.

18. The medical information verification system according to claim 17, wherein
the medium information includes link information to access the medical management target file stored in the shared server.
